(19) United States
(12) Patent Application Publication
(10) Pub. No.: US 2025/0390609 A1
(43) Pub. Date: Dec. 25, 2025

(54) CODE INTEGRITY PRESERVING COMPILER

(71) Applicant: QUALCOMM Incorporated, San Diego, CA (US)

(72) Inventor: Alessandro MANTOVANI, San Diego, CA (US)

(21) Appl. No.: 18/751,049

(22) Filed: Jun. 21, 2024

(51) Int. Cl. G06F 21/64; G06F 8/41; H04L 9/32

(52) U.S. Cl. CPC G06F 21/64; G06F 8/41; H04L 9/3242; H04L 9/3247

(57) ABSTRACT

Systems and techniques are provided for compiling source code. For instance a process can include: obtaining, from a source code repository, a first overall hash of a first hash of a first portion of source code; generating a second overall hash of the first hash of the first portion of source code; verifying the first overall hash based on a determination that the first overall hash is equal to the second overall hash; obtaining, from the source code repository, the first portion of source code; loading the first portion of source code into a volatile memory system; generating a second hash of the first portion of source code in the volatile memory system; verifying the first portion of source code based on a determination that the first hash is equal to the second hash; and compiling the first portion of source code.

### FIELD

Aspects of the present disclosure generally relate to application security. For example, aspects of the present disclosure relate to a code integrity preserving compiler.

### INTRODUCTION

Computing devices may execute software to perform a variety of functions. Modern software may be written in a high level, human readable, programming language, such as C++, Basic, Rust, etc. as source code. This source code may be stored in a source code repository, which may be a storage location for source code and other assets that may be used in an application The source code repository may also handle tasks related to the source code, such as tracking and managing the source code, collaboration, synchronization, version control, and the like. Sometimes, the source code repositories may be remote from a developer, such as on a remote server. To turn the source code into machine readable code that can be executed by a computer, the source code may be compiled (e.g., built). For example, the source code may be downloaded from the source code repository to a build machine (e.g., computer compiling the source code) and compiled by a compiler executing on the build machine.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for application security. According to at least one illustrative example, an electronic device is provided. The electronic device includes a memory system comprising instructions; and a processor system coupled to the memory system. The processor system is configured to: obtain, from a source code repository, a first overall hash of a first hash of a first portion of source code; generate a second overall hash of the first hash of the first portion of source code; verify the first overall hash based on a determination that the first overall hash is equal to the second overall hash; obtain, from the source code repository, the first portion of source code; load the first portion of source code into the volatile memory system; generate a second hash of the first portion of source code in the volatile memory system; verify the first portion of source code based on a determination that the first hash is equal to the second hash; and compile the first portion of source code.

As another example, a method for compiling source code is provided. The method includes obtaining, from a source code repository, a first overall hash of a first hash of a first portion of source code; generating a second overall hash of the first hash of the first portion of source code; verifying the first overall hash based on a determination that the first overall hash is equal to the second overall hash; obtaining, from the source code repository, the first portion of source code; loading the first portion of source code into a volatile memory system; generating a second hash of the first portion of source code in the volatile memory system; verifying the first portion of source code based on a determination that the first hash is equal to the second hash; and compiling the first portion of source code.

In another example, a non-transitory computer-readable medium having stored thereon instructions is provided. The instruction, when executed by a processor system, cause the processor system to: obtain, from a source code repository, a first overall hash of a first hash of a first portion of source code; generate a second overall hash of the first hash of the first portion of source code; verify the first overall hash based on a determination that the first overall hash is equal to the second overall hash; obtain, from the source code repository, the first portion of source code; load the first portion of source code into a volatile memory system; generate a second hash of the first portion of source code in the volatile memory system; verify the first portion of source code based on a determination that the first hash is equal to the second hash; and compile the first portion of source code.

As another example, an apparatus for compiling source code is provided. The apparatus includes: means for obtaining, from a source code repository, a first overall hash of a first hash of a first portion of source code; means for generating a second overall hash of the first hash of the first portion of source code; means for verifying the first overall hash based on a determination that the first overall hash is equal to the second overall hash; means for obtaining, from the source code repository, the first portion of source code; means for loading the first portion of source code into a volatile memory system; means for generating a second hash of the first portion of source code in the volatile memory system; means for verifying the first portion of source code based on a determination that the first hash is equal to the second hash; and means for compiling the first portion of source code.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations (e.g., processors (such as CPU, GPU, DSP, NPU), memory or storage component(s), electronic blocks which ensure I/O connectivity and multimedia capabilities, and hardware modules associated with sensors or processing data from sensors, Image Signal Processors (ISPs), embedded discrete secure hardware modules, etc. or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example implementation of a system-on-a-chip (SoC), in accordance with some examples;

FIG. 2 is a block diagram illustrating an operating environment of build pipeline, in accordance with aspects of the present disclosure;

FIG. 3 is a block diagram illustrating a build pipeline using a code integrity preserving compiler, in accordance with aspects of the present disclosure;

FIG. 4 is a block diagram illustrating a compilation process of a code integrity preserving compiler 410, in accordance with aspects of the present disclosure;

FIG. 5 is a flow diagram illustrating an example of a process for compiling source code, in accordance with aspects of the present disclosure; and

FIG. 6 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Recently, nefarious parties have started to take advantage of this separation between the source code repository and the build machine to perform downstream attacks using the compiled source code (e.g., the application). For example, an attacker may try to compromise the build machine to change the source code just prior to compiling to cause the compiled application to act maliciously without the knowledge of the developers of the application. To help enhance trust and security of applications, a code integrity preserving compiler may be useful.

Systems, apparatuses, processes (also referred to as methods), and computer-readable media (collectively referred to as “systems and techniques”) are described herein for compiling source code, in accordance with aspects of the present disclosure. For example, source code may be stored in a code repository along with a digital signature and first hash of the source code. In some cases, the digital signature and first hash may be generated by a developer of the source code. A build machine may obtain the source code from the code repository and load the source code into a volatile memory accessible only from the compiler itself (e.g., random access memory (RAM), static RAM (SRAM), dynamic RAM (DRAM)) of the build machine. The in-memory version of the source code may be hashed to generate a second hash. The second hash may be compared to the first hash to verify the source code. If the hashes are the same, then compilation of the source code may continue. If the hashes are different, then compilation of the source code may be halted.

Various aspects of the present disclosure will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The term “mobile device” is used herein to refer to any one or all of cellular telephones, smartphones, Internet-of-things (IOT) devices, personal or mobile multi-media players, laptop computers, tablet computers, ultrabooks, palm-top computers, wireless electronic mail receivers, multimedia Internet enabled cellular telephones, wireless gaming controllers, smart cars, autonomous vehicles, and similar electronic devices which include a programmable processor, a memory and circuitry for sending and/or receiving wireless communication signals to/from wireless communication networks. While the various embodiments are particularly useful in mobile devices, such as smartphones and tablets, the embodiments are generally useful in any electronic device that includes secure boot circuitry for securing access to the electronic device.

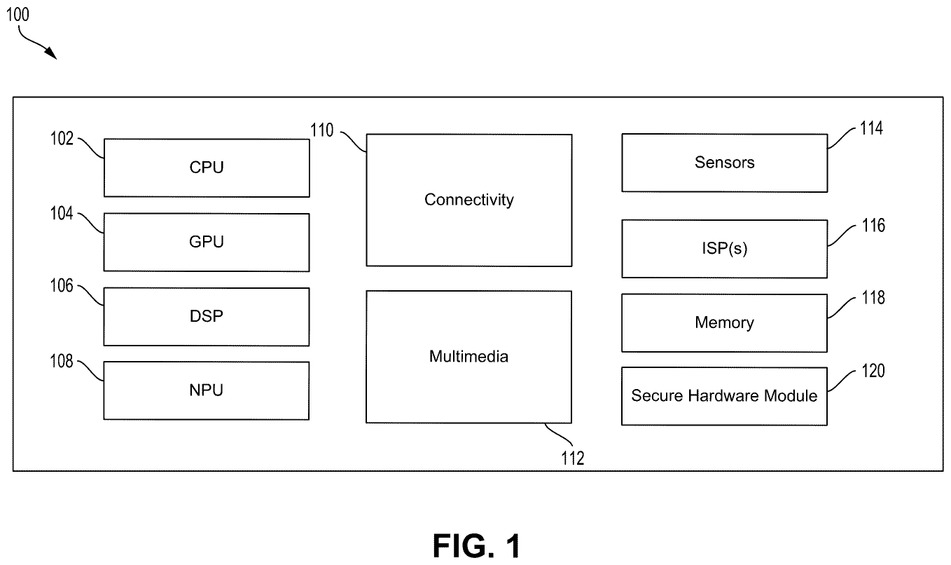

Various aspects of the techniques described herein will be discussed below with respect to the figures. FIG. 1. FIG. 1 illustrates an example implementation of a system-on-a-chip (SoC) 100, which may include a central processing unit (CPU) 102 or a multi-core CPU, configured to perform one or more of the functions described herein. Parameters or variables (e.g., neural signals and synaptic weights), system parameters associated with a computational device (e.g., neural network with weights), delays, frequency bin information, task information, among other information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, and/or may be distributed across multiple blocks. Instructions executed at the CPU 102 may be loaded from a program memory associated with the CPU 102 or may be loaded from a memory block 118.

In some cases, the SoC 100 may be based on an ARM instruction set. The SoC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, DSP 106, and/or GPU 104. The SoC 100 may also include a sensor processor 114, image signal processors (ISPs) 116, and/or a secure hardware module 120.

The secure hardware module 120 may include fuses, replay protected memory block (RPMB), secure bits, secure flags, security enabled hardware, secure memory, or hardware, software, or firmware used to implement a secure portion of the operating system, a secure operating system (SOS), a trusted execution environment (TEE), trusted platform module (TPM), etc. The secure hardware module 120 may be used to process and/or store sensitive data in an environment that is segregated from the rich execution environment in which the operating system and/or applications may be executed. The secure hardware module 120 can be configured to execute trusted applications that provide end-to-end security for sensitive data by enforcing confidentiality, integrity, and protection of the sensitive data stored therein. The secure hardware module 120 can be used to store encryption keys, access tokens, and other sensitive data. In some cases, the secure hardware module 120 may serve as a RoT for the SoC 100. For example, the secure hardware module 120 may provide for the secure generation of cryptographic keys, limitations on the use of such cryptographic keys, and may contain one or more cryptographic keys or elements that may be used to authenticate the SoC 100. In some cases, the RoT may serve to anchor a chain of trust to validate other hardware and/or software. In some cases, the secure hardware module 120 may be implemented as a secure area of the CPU 102, as a part of the SoC 100, or any combination thereof.

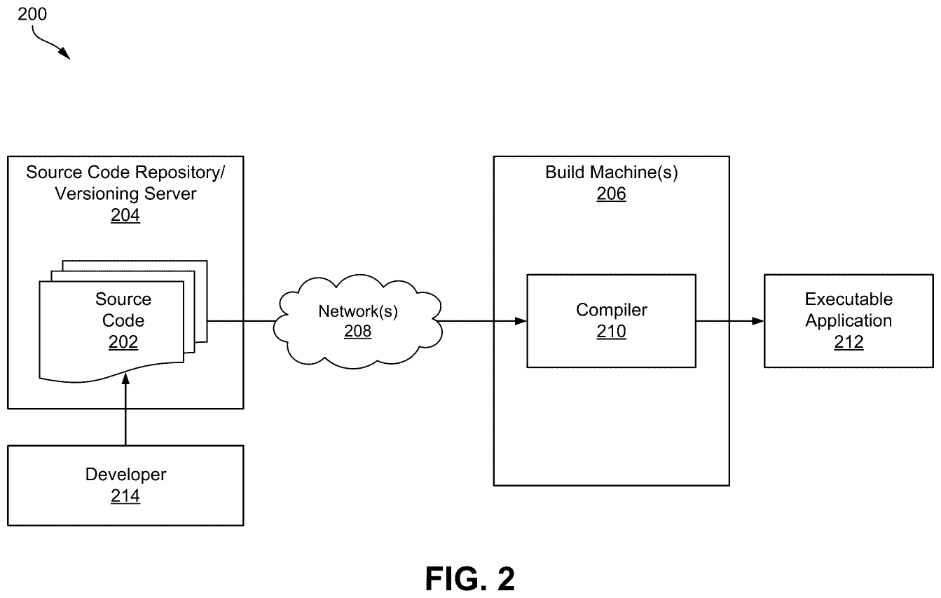

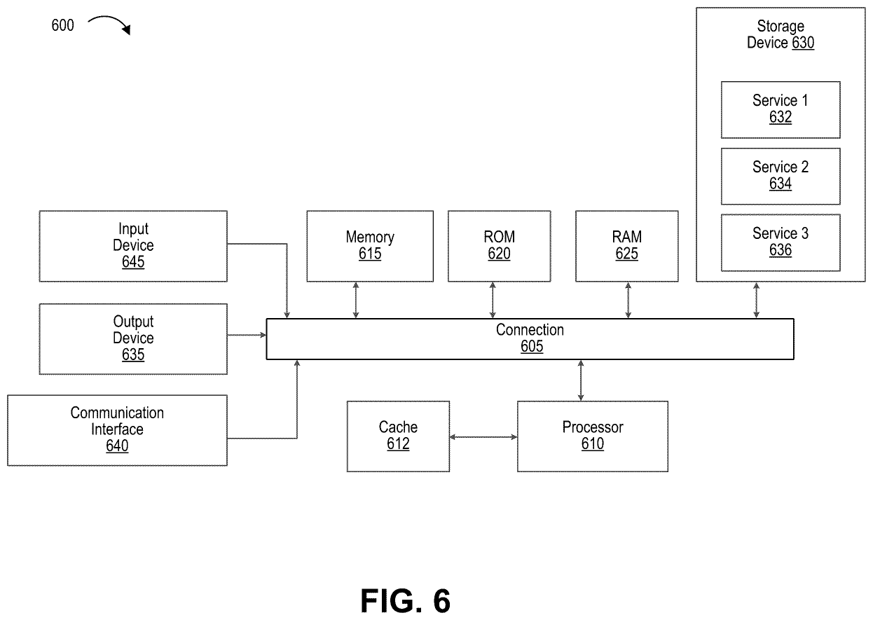

FIG. 2 is a block diagram illustrating an operating environment of build pipeline 200, in accordance with aspects of the present disclosure. In discussed herein, the build pipeline 200 may represent a step in a pipeline of a continuous integration and continuous delivery (CICD) process (e.g., build pipeline, test pipeline, release pipeline, etc.). The build pipeline 200 may be used to centrally track and manage source code 202 that may be stored on in a source code repository 204 (e.g., versioning server). For example, a developer 214 working on the source code 202, may check out certain portions (e.g., files) of the source code 202, make changes to those portions of the source code 202, and check those portions back into the source code repository 204. In some cases, the source code repository 204 may be separate (e.g., logically or physically) from a device that the developer may be using. In some cases, the source code repository 204 may be a server device, cloud hosted, virtualized computer, distributed server, or the like. In some cases, the source code repository 204 may have an architecture similar to that shown with respect to FIG. 1 or FIG. 6.

In some cases, the build pipeline 200 may also include a build machine 206. The build machine 206 may be separate (e.g., logically or physically) from the source code repository 204, and the build machine 206 may be coupled to the source code repository 204 via a network 208. The network 208 may be any computer network (e.g., ethernet, local area network, wide area network, wireless network, the internet, etc.). The build machine 206 may be any device coupled to the source code repository 204 that is configured to download and compile the source code 202. In some cases, the build machine 206 may be a client device, server device, cloud hosted, virtualized computer, distributed device, multiple devices, or the like. In some cases, the build machine 206 may have an architecture similar to that shown with respect to FIG. 1 or FIG. 6.

The build machine 206 may include a compiler 210 (and associated applications/modules for preparing an executable application 212 from source code and resources, such as linking, resource preparation, signing, etc.) for compiling the source code 202 into the executable application 212 (e.g., application, patch, update, or other machine-readable code).

In some cases, to perform an attack on a target, an attacker may first attempt to compromise a vendor which makes software that the target uses. For example, the attacker may attempt to attack the build machine 206, source code repository 204, perform a man-in-the-middle attack between the source code repository 204 and the build machine 206 of the vendor, steal developer credentials, etc. Such an attack may allow the attacker to modify the source code 202 prior to and/or during compiling to cause the compiled executable application 212 to perform attacks on the target when the executable application 212 is run by the target. As the vendor may not know that the source code 202 has been changed, the vendor may sign the executable application 212 and the target may trust the signed executable application 212, making such attacks dangerous and difficult to detect by the target.

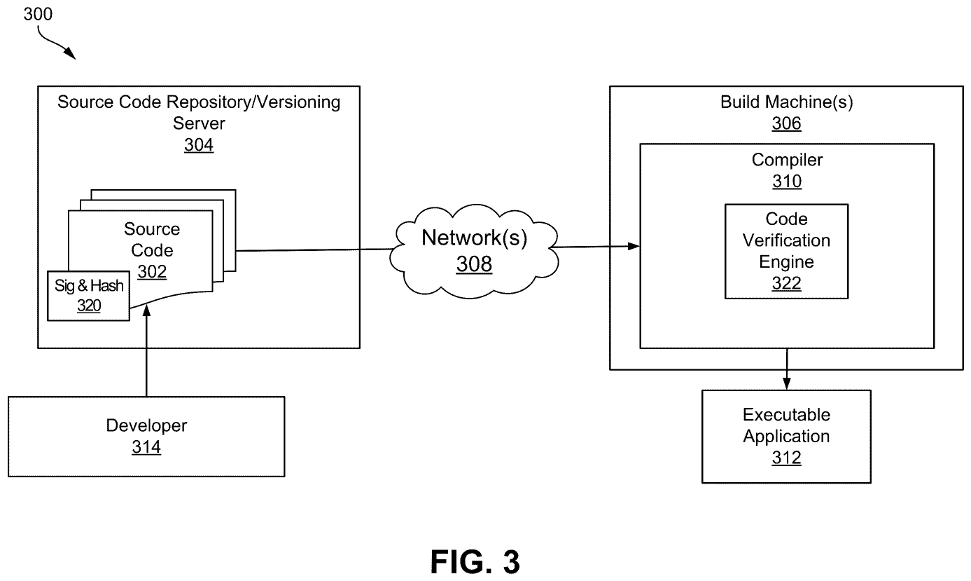

FIG. 3 is a block diagram illustrating a build pipeline 300 using a code integrity preserving compiler, in accordance with aspects of the present disclosure. In some cases, the build pipeline 300 may be similar to the build pipeline 200 of FIG. 2 and elements of FIG. 3 which are similar to elements of FIG. 2 have a similar numbering scheme. The build pipeline 300 may include a source code repository 304 storing source code 302 coupled via a network 308 to a build machine 306 with a compiler 310 that may build an executable application 312. As described in FIG. 2, a developer 314 working on the source code 302, may check out certain portions (e.g., files) of the source code 302 and make changes to those portions of the source code 302.

In some cases, to check the source code 302 back in, the developer 314 may generate a hash of the portions of the source code 302 that were checked out and a signature (hash and signature 320). The hash of the portions of the source code 302 may be generated using any hashing technique such as MD-5, SHA-256, etc. and the signature may be generated using any digital signature algorithm such as DSA, DSS, etc. In some cases, the signature and hash may be stored in a text file along with a pointer or other indication of the associated portion (e.g., file) of the source code 302. In some cases, the signature and hash may be generated at a file level and provide file level granularity protection. In some cases, this may be extended to cover line level granularity for lines that are changed by the developer 314 in a file. The signature indicates that the party that applied the signature made the changes to the source code and the hash may be used to detect if any unauthorized changes to the source code are made. In some cases, the hash may be embedded in the signature. The developer 314 may upload the portion of the source code 302 worked on, along with the hash and signature 320 to the source code repository 304. The source code 302 may be stored along with the hash and signature 320 by the source code repository 304.

In some cases, rather than having the developer generate the hash and signature 320 to check in portions of the source code 302, the source code repository 304 may generate the hash and signature 320. For example, the source code repository 304 may generate a hash of portions of the source code 302 that are being checked in (or just checked in) and sign the portions of the source code 302 with a signature of the source code repository, or signature of the developer 314 performing the check in. The source code 302 may be stored along with the hashes and signature 320 by the source code repository 304.

In some cases, the source code repository 304 may generate an overall signature and hash of the hashes and signatures 320. For example, the source code repository 304 may generate a hash of all of hashes and signatures 320 (in a particular order) and sign the generated hash to obtain (e.g., obtaining, generating, determining, etc.) the overall signature and hash. To build (e.g., compile) the source code 302, a code verification engine 322 of the compiler 310 may first verify the overall signature and hash of the hashes and signatures 320. For example, The build machine 306 may obtain the hashes and signatures 320 associated with the source code 302 via the network 308. The build machine 306 may generate a hash value based on the hashes and signatures 320 and verify that the generated hash value matches a hash value in the overall signature. The build machine 306 may also obtain a public key of the build machine and verify the signature of the overall signature and hash based on the public key of the build machine. Verifying the overall signature and hash may help prevent an attacker from sending an arbitrary file with a hash and signature to the build machine 306 to build. In some cases, the build machine 306 may automatically obtain the source code 302 periodically, at a set time, as directed, etc., verify the overall signature and hash, and compile the source code.

After verifying the overall signature and hash, the build machine 306 may compile the source code 302. In some cases, the build machine 306 may obtain (e.g., download, access, copy, etc.) the source code 302 based on the verification of the overall signature and hash. In some cases, the complier 310 may compile the source code 302 by first loading portions (e.g., files) of the source code 302 into memory. After a portion of the source code 302 is loaded into memory, a code verification engine 322 may generate hash values based on the portions of the source code 302 and verify the generated hash values against the hash values obtained from the source code repository 304 (e.g., from the hashes and signature 320 associated with the source code 302) along with verifying the signatures. After the portions of the source code 302 are verified, the compiler 310 can continue processing the source code 302 to generate the executable application 312. If the portions of the source code 302 are not successfully verified, an error may be raised.

In some cases, the code verification engine 322 may be implemented using a module or plug-in for the compiler 310 and the compiler 310 may be any compiler that support such modules or plug-ins, such as a Clang, LLVM, etc. Verifying the hashes and signatures 320 of portions of the source code 302 after those portions have been read into a volatile memory (e.g., dynamic random access memory (DRAM), static random access memory (SRAM), etc.) by the compiler 310 helps avoid potential attacks that may attempt to change the source code 302 while the source code 302 is at rest (e.g., not being used, stored in long term non-volatile memory (e.g., storage), such as a hard disk, flash storage, etc., which may be a shared space (e.g., shared with other applications)). Loading the portion of the source code 302 into volatile memory may load the portions of the source code 302 into a protected memory space of the application, which may be more difficult to attack as compared to a shared space. In some cases, the compiler 310 may also be executed in a sandbox or as a root application. In some cases, executing the compiler 310 as root may help prevent a debugger from being attached to the compiler 310 to access the protected memory space and/or other information internal to the compiler 310.

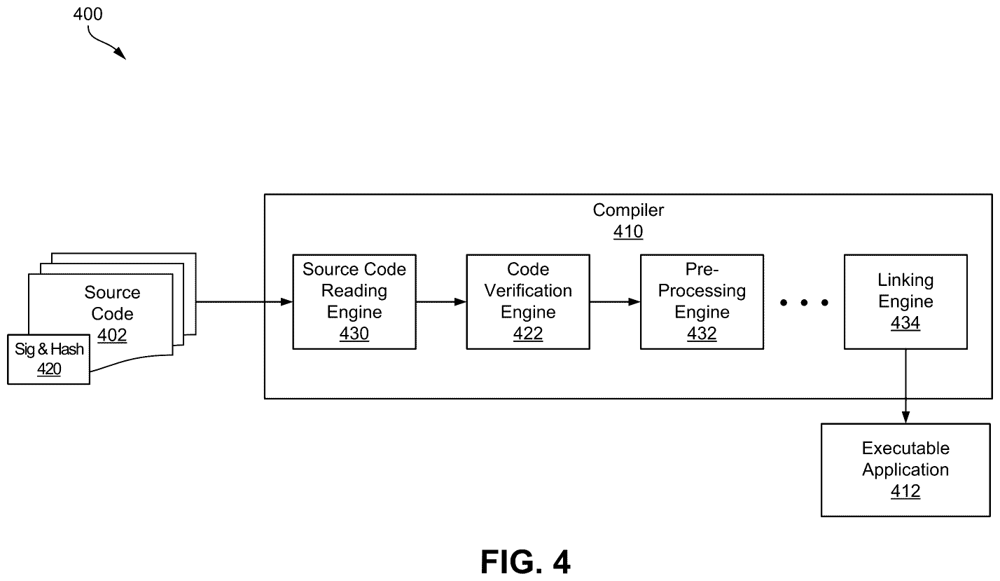

FIG. 4 is a block diagram illustrating a compilation process 400 of a code integrity preserving compiler 410, in accordance with aspects of the present disclosure. In some cases, the compiler 410 may be substantially similar to compiler 310 of FIG. 3. As shown in FIG. 4, a source code reading engine 430 of the compiler 410 may access one or more portions of the source code 402 along with signatures and hashes 420 associated with those portions of the source code 402 and load the one or more portions of the source code 402 along with signatures and hashes 420 into a volatile memory of the build machine.

Once the one or more portions of the source code 402 and the signatures and hashes 420 are loaded into volatile memory. A code verification engine 422 may then be executed on the one or more portions of the source code 402 in the volatile memory. In some cases, the code verification engine 422 may be substantially similar to code verification engine 322 of FIG. 3. In some cases, the code verification engine 422 may verify the signature and hashes 420 of the one or more portions of the source code 402. For example, a digital signature may be generated by hashing a portion of the source code 402 and then encrypting the hash using a signer's private key to generate the signature and hashes 420. The code verification engine 422 may use the signer's public key to decrypt the encrypted hash. The code verification engine 422 may also generate a hash of the portion of the source code 402 in volatile memory and then verify that the hash generated by the code verification engine is the same as the decrypted hash from the signature and hashes 420. If the hashes are not the same, then the code verification engine 422 may raise an error and stop the compilation process.

If the hashes are the same, the compilation may continue. For example, the ordinary compilation process for the language may be performed. As a more detailed example, a pre-processing engine 432 may be called to pre-process the portion of the source code to remove comments, expand macros, and so forth. After pre-processing a compilation process, assembly process, and linking process by a linking engine 434 may be performed to generate an executable application 412. In some cases, the code verification engine 422 may perform the verification of the signature and hash 420 as close to the when the portions of the source code 402 are loaded into volatile memory as practicable to avoid spending computing resources on compiling unverified source code.

In some cases, the executable application 412 may be protected in a manner similar to protecting the source code. For example, a hash and signature for portions (e.g., files) of the executable application 412 may be generated while those portions are still in volatile memory of the compiler. The hash and signatures generated with the executable application 412 may be output with the executable application 412.

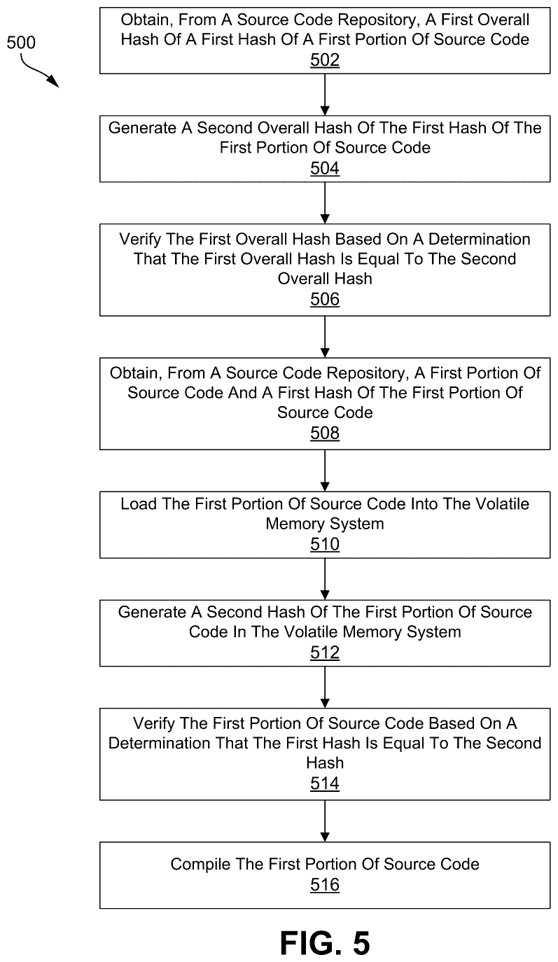

FIG. 5 is a flow diagram illustrating an example of a process 500 for compiling source code, in accordance with aspects of the present disclosure. The process 500 may be performed by a device or by a component (e.g., SoC 100 of FIG. 1, processor 610 of FIG. 6, etc.) or system (e.g., a chipset) of the device (e.g., build machine 206 of FIG. 2, build machine 306 of FIG. 3, computing system 600, etc.). The electronic device may be a wireless or wired device, such as computing system 600 (e.g., a mobile device such as a mobile phone, a network device, such as one or more servers,) or other type of network node. In some examples, the process 500 may be performed by a server or client device. The operations of the process 500 may be implemented, in part, as software components that are executed and run on one or more processors (e.g., CPU 102 of FIG. 1, processor 610 of FIG. 6, or other processor(s)).

At block 502, the computing device (or component thereof) may obtain, from a source code repository (e.g., source code repository 304 of FIG. 3), a first overall hash of a first hash of a first portion of source code (e.g., source code 302 of FIG. 3). For example, the source code repository may generate a hash of all of hashes and signatures (in a particular order) and sign the generated hash to generate the overall signature and hash. A build machine may obtain (e.g., download, access, copy, etc.) the overall signature and hash. In some cases, the computing device (or component thereof) may be a build device separate from the source code repository. In some examples, the first hash is generated by a developer of the first portion of source code. In some cases, the first overall hash is signed with a digital signature of the source code repository. In some examples, the computing device (or component thereof) may verify the digital signature based on a public key of the source code repository.

At block 504, the computing device (or component thereof) may generate a second overall hash of the first hash of the first portion of source code. For example, build machine (e.g., a code verification engine of a compiler executing on the build machine) may generate a hash value based on the hashes and signatures.

At block 506, the computing device (or component thereof) may verify the first overall hash based on a determination that the first overall hash is equal to the second overall hash. For example, the build machine may generate a hash value based on the hashes and signatures and verify that the generated hash value matches a hash value in the overall signature.

At block 508, the computing device (or component thereof) may obtain, from the source code repository, the first portion of source code. In some cases, the build machine may obtain (e.g., download) the source code based on the verification of the overall signature and hash.

At block 510, the computing device (or component thereof) may load the first portion of source code into the volatile memory system (e.g., memory 118 of FIG. 1, memory 615 of FIG. 6, etc.). In some cases, the first portion of source code is signed with a digital signature of a signer. In some examples, the computing device (or component thereof) may verify the digital signature based on a public key of the signer.

At block 512, the computing device (or component thereof) may generate a second hash of the first portion of source code in the volatile memory system.

At block 514, the computing device (or component thereof) may verify the first portion of source code based on a determination that the first hash is equal to the second hash. In some cases, generating the second hash and verifying the first portion of source code are performed by a module of a compiler executing on the computing device (or component thereof).

At block 516, the computing device (or component thereof) may compile the first portion of source code. In some cases, the computing device (or component thereof) may obtain a second portion of source code and a third hash of the second portion of source code; load the second portion of the source code into the volatile memory system; generate a fourth hash of the second portion of source code in the volatile memory system; and generate an error based on a determination that the third hash is not equal to the fourth hash.

In some examples, the processes described herein (e.g., process 500, and/or other process described herein) may be performed by a computing device or apparatus (e.g., a network node such as a UE, base station, a portion of a base station, etc.). For example, as noted above, one or more of the processes described herein (e.g., the process 500, and/or other process described herein) may be performed by a UE.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 500 is illustrated as a logical flow diagram, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, process 500 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 6 is a diagram illustrating an example of a system for implementing certain aspects of the present technology. In particular, FIG. 6 illustrates an example of computing system 600, which may be for example any computing device making up internal computing system, a remote computing system, a camera, or any component thereof in which the components of the system are in communication with each other using connection 605. Connection 605 may be a physical connection using a bus, or a direct connection into processor 610, such as in a chipset architecture. Connection 605 may also be a virtual connection, networked connection, or logical connection.

In some aspects, computing system 600 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example computing system 600 includes at least one processing unit (CPU or processor) 610 and connection 605 that communicatively couples various system components including system memory 625, such as read-only memory (ROM) 620 and random access memory (RAM) 625 to processor 610. Computing system 600 may include a cache 612 of high-speed memory connected directly with, in close proximity to, or integrated as part of processor 610.

Processor 610 may include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which may represent any number of input mechanisms, such as a microphone for speech, a touch-sensitive screen for gesture or graphical input, keyboard, mouse, motion input, speech, etc. Computing system 600 may also include output device 635, which may be one or more of a number of output mechanisms. In some instances, multimodal systems may enable a user to provide multiple types of input/output to communicate with computing system 600.

Computing system 600 may include communications interface 640, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 630 may include software services, servers, services, etc., that when the code that defines such software is executed by the processor 610, it causes the system to perform a function. In some aspects, a hardware service that performs a particular function may include the software component stored in a computer-readable medium in connection with the necessary hardware components, such as processor 610, connection 605, output device 635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed by one or more processors, performs one or more of the methods, algorithms, and/or operations described above. The computer-readable data storage medium may form part of a computer program product, which may include packaging materials. The computer-readable medium and/or memory system may comprise any memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, memory 615, read-only memory (ROM) 620, random access memory (RAM) 625, storage device 630, and the like, and the computer-readable medium may include multiple memories or data storage media. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor system, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor system may be configured to perform any of the techniques described in this disclosure. A general-purpose processor may be a microprocessor; but in the alternative, the processor may be any conventional processor, controller, microcontroller, or state machine. A processor system may also be implemented as a combination of computing devices, e.g., a combination of a DSP and a microprocessor, a plurality of microprocessors, one or more microprocessors in conjunction with a DSP core, or any other such configuration. Accordingly, the term “processor system,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another clement (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for compiling source code, comprising: a volatile memory system including instructions; and a processor system coupled to the volatile memory system, wherein the processor system is configured to: obtain, from a source code repository, a first overall hash of a first hash of a first portion of source code; generate a second overall hash of the first hash of the first portion of source code; verify the first overall hash based on a determination that the first overall hash is equal to the second overall hash; obtain, from the source code repository, the first portion of source code; load the first portion of source code into the volatile memory system; generate a second hash of the first portion of source code in the volatile memory system; verify the first portion of source code based on a determination that the first hash is equal to the second hash; and compile the first portion of source code.

Aspect 2. The apparatus of Aspect 1, wherein the processor system is further configured to: obtain a second portion of source code and a third hash of the second portion of source code; load the second portion of the source code into the volatile memory system; generate a fourth hash of the second portion of source code in the volatile memory system; and generate an error based on a determination that the third hash is not equal to the fourth hash.

Aspect 3. The apparatus of any of Aspects 1-2, wherein the first portion of source code is signed with a digital signature of a signer.

Aspect 4. The apparatus of Aspect 3, wherein the processor system is further configured to verify the digital signature based on a public key of the signer.

Aspect 5. The apparatus of any of Aspects 1-4, wherein generating the second hash and verifying the first portion of source code are performed by a module of a compiler.

Aspect 6. The apparatus of any of Aspects 1-5, wherein the apparatus comprises a build device separate from the source code repository.

Aspect 7. The apparatus of any of Aspects 1-6, wherein the first hash is generated by a developer of the first portion of source code.

Aspect 8. The apparatus of any of Aspects 1-7, wherein the first overall hash is signed with a digital signature of the source code repository, and wherein the processor system is further configured to verify the digital signature based on a public key of the source code repository.

Aspect 9. A method for compiling source code, comprising: obtaining, from a source code repository, a first overall hash of a first hash of a first portion of source code; generating a second overall hash of the first hash of the first portion of source code; verifying the first overall hash based on a determination that the first overall hash is equal to the second overall hash; obtaining, from the source code repository, the first portion of source code; loading the first portion of source code into a volatile memory system; generating a second hash of the first portion of source code in the volatile memory system; verifying the first portion of source code based on a determination that the first hash is equal to the second hash; and compiling the first portion of source code.

Aspect 10. The method of Aspect 9, further comprising: obtaining a second portion of source code and a third hash of the second portion of source code; loading the second portion of the source code into the volatile memory system; generating a fourth hash of the second portion of source code in the volatile memory system; and generating an error based on a determination that the third hash is not equal to the fourth hash.

Aspect 11. The method of any of Aspects 9-10, wherein the first portion of source code is signed with a digital signature of a signer.

Aspect 12. The method of Aspect 11, further comprising verifying the digital signature based on a public key of the signer.

Aspect 13. The method of any of Aspects 9-12, wherein generating the second hash and verifying the first portion of source code are performed by a module of a compiler.

Aspect 14. The method of any of Aspects 9-13, wherein the first hash is generated by a developer of the first portion of source code.

Aspect 15. The method of any of Aspects 9-14, wherein the first overall hash is signed with a digital signature of the source code repository, and further comprising verifying the digital signature based on a public key of the source code repository.

Aspect 16. A non-transitory computer-readable medium having stored thereon instructions that, when executed by a processor system, cause the processor system to: obtain, from a source code repository, a first overall hash of a first hash of a first portion of source code; generate a second overall hash of the first hash of the first portion of source code; verify the first overall hash based on a determination that the first overall hash is equal to the second overall hash; obtain, from the source code repository, the first portion of source code; load the first portion of source code into a volatile memory system; generate a second hash of the first portion of source code in the volatile memory system; verify the first portion of source code based on a determination that the first hash is equal to the second hash; and compile the first portion of source code.

Aspect 17. The non-transitory computer-readable medium of Aspect 16, wherein the instructions cause the processor system to: obtain a second portion of source code and a third hash of the second portion of source code; load the second portion of the source code into the volatile memory system; generate a fourth hash of the second portion of source code in the volatile memory system; and generate an error based on a determination that the third hash is not equal to the fourth hash.

Aspect 18. The non-transitory computer-readable medium of any of Aspects 16-17, wherein the first portion of source code is signed with a digital signature of a signer.

Aspect 19. The non-transitory computer-readable medium of Aspect 18, wherein the instructions cause the processor system to verify the digital signature based on a public key of the signer.

Aspect 20. The non-transitory computer-readable medium of any of Aspects 16-19, wherein generating the second hash and verifying the first portion of source code are performed by a module of a compiler.

Aspect 21. The transitory computer-readable medium of any of Aspects 16-20, wherein the first hash is generated by a developer of the first portion of source code.

Aspect 22. The transitory computer-readable medium of any of Aspects 16-21, wherein the first overall hash is signed with a digital signature of the source code repository, and wherein the instructions cause the processor system to verify the digital signature based on a public key of the source code repository.

Aspect 23. An apparatus for wireless communications, comprising one or more means for performing operations according to any of Aspects 9 to 15.

What is claimed is:

1. An apparatus for compiling source code, comprising:
a volatile memory system including instructions; and
a processor system coupled to the volatile memory system, wherein the processor system is configured to:
obtain, from a source code repository, a first overall hash of a first hash of a first portion of source code;
generate a second overall hash of the first hash of the first portion of source code;
verify the first overall hash based on a determination that the first overall hash is equal to the second overall hash;
obtain, from the source code repository, the first portion of source code;
load the first portion of source code into the volatile memory system;
generate a second hash of the first portion of source code in the volatile memory system;
verify the first portion of source code based on a determination that the first hash is equal to the second hash; and
compile the first portion of source code.

2. The apparatus of claim 1, wherein the processor system is further configured to:
obtain a second portion of source code and a third hash of the second portion of source code;
load the second portion of the source code into the volatile memory system;
generate a fourth hash of the second portion of source code in the volatile memory system; and
generate an error based on a determination that the third hash is not equal to the fourth hash.

3. The apparatus of claim 1, wherein the first portion of source code is signed with a digital signature of a signer.

4. The apparatus of claim 3, wherein the processor system is further configured to verify the digital signature based on a public key of the signer.

5. The apparatus of claim 1, wherein generating the second hash and verifying the first portion of source code are performed by a module of a compiler.

6. The apparatus of claim 1, wherein the apparatus comprises a build device separate from the source code repository.

7. The apparatus of claim 1, wherein the first hash is generated by a developer of the first portion of source code.

8. The apparatus of claim 1, wherein the first overall hash is signed with a digital signature of the source code repository, and wherein the processor system is further configured to verify the digital signature based on a public key of the source code repository.

9. A method for compiling source code, comprising:
obtaining, from a source code repository, a first overall hash of a first hash of a first portion of source code;
generating a second overall hash of the first hash of the first portion of source code;
verifying the first overall hash based on a determination that the first overall hash is equal to the second overall hash;
obtaining, from the source code repository, the first portion of source code;
loading the first portion of source code into a volatile memory system;
generating a second hash of the first portion of source code in the volatile memory system;
verifying the first portion of source code based on a determination that the first hash is equal to the second hash; and
compiling the first portion of source code.

10. The method of claim 9, further comprising:
obtaining a second portion of source code and a third hash of the second portion of source code;
loading the second portion of the source code into the volatile memory system;
generating a fourth hash of the second portion of source code in the volatile memory system; and
generating an error based on a determination that the third hash is not equal to the fourth hash.

11. The method of claim 9, wherein the first portion of source code is signed with a digital signature of a signer.

12. The method of claim 11, further comprising verifying the digital signature based on a public key of the signer.

13. The method of claim 9, wherein generating the second hash and verifying the first portion of source code are performed by a module of a compiler.

14. The method of claim 9, wherein the first hash is generated by a developer of the first portion of source code.

15. The method of claim 9, wherein the first overall hash is signed with a digital signature of the source code repository, and further comprising verifying the digital signature based on a public key of the source code repository.

16. A non-transitory computer-readable medium having stored thereon instructions that, when executed by a processor system, cause the processor system to:
obtain, from a source code repository, a first overall hash of a first hash of a first portion of source code;
generate a second overall hash of the first hash of the first portion of source code;
verify the first overall hash based on a determination that the first overall hash is equal to the second overall hash;
obtain, from the source code repository, the first portion of source code;
load the first portion of source code into a volatile memory system;
generate a second hash of the first portion of source code in the volatile memory system;
verify the first portion of source code based on a determination that the first hash is equal to the second hash; and
compile the first portion of source code.

17. The non-transitory computer-readable medium of claim 16, wherein the instructions cause the processor system to:
obtain a second portion of source code and a third hash of the second portion of source code;
load the second portion of the source code into the volatile memory system;
generate a fourth hash of the second portion of source code in the volatile memory system; and
generate an error based on a determination that the third hash is not equal to the fourth hash.

18. The non-transitory computer-readable medium of claim 16, wherein the first portion of source code is signed with a digital signature of a signer.

19. The non-transitory computer-readable medium of claim 18, wherein the instructions cause the processor system to verify the digital signature based on a public key of the signer.

20. The non-transitory computer-readable medium of claim 16, wherein generating the second hash and verifying the first portion of source code are performed by a module of a compiler.
